(19) United States
(12) Patent Application Publication
(10) Pub. No.: US 2022/0065888 A1
(43) Pub. Date: Mar. 3, 2022

(54) PIPETTE ACCESSORY FOR RELIABLE LIQUID HANDLING

(71) Applicant: PrepFree LLC, Las Vegas, NV (US)

(72) Inventors: Jack Chou LEO, La Jolla, CA (US); Yongdong WANG, Las Vegas, NV (US)

(73) Assignee: PrepFree LLC, Las Vegas, NV (US)

(21) Appl. No.: 17/461,712

(22) Filed: Aug. 30, 2021

Related U.S. Application Data
(60) Provisional application No. 63/072,188, filed on Aug. 30, 2020.

(51) Int. Cl. G01N 35/10; G01N 35/00; B01L 3/02; B01L 9/00

(52) U.S. Cl. CPC G01N 35/1081; G01N 35/00722; B01L 3/0217; B01L 3/545; B01L 3/0282; B01L 9/54; B01L 2300/0609; B01L 3/0286

(57) ABSTRACT

An apparatus for limiting pipette motion, the apparatus comprising: (1) a stand for controlling spatial positions; (2) a mechanism for temporally coupling the pipette with the stand; the orientation or the movement of the pipette being restricted by the stand as predetermined for (a) limiting the insertion depth of the pipette tips into sample containers, (b) restricting unwanted movements or rotations of the pipette, or (c) maintaining the desired alignments of the pipette tips with the sample containers. Methods of limiting pipette motion or rotation are also provided.

This application claims priority from provisional patent application Ser. No. 63/072,188, filed on Aug. 30, 2020, which is incorporated herein by reference, in its entirety, for all purposes.

### BACKGROUND OF THE DISCLOSURE

### 1. Field of the Disclosure

The present disclosure relates to an apparatus and method for limiting pipette movement and/or rotation with respect to a support surface for placing sample containers, and, more particularly, to an apparatus and method for restricting the orientation or the movement of the pipette as predetermined by a stand for (a) limiting the insertion depth of the pipette tips into sample containers or (b) restricting unwanted movements and/or rotations of the pipette or (c) maintaining the desired alignments of the pipette tips with the sample containers.

### 2. Description of the Related Art

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

In laboratory settings, a single-channel pipette and/or a multichannel pipette may be used to transfer fluids into and out of containers, often in tubes of sample rack or wells of a microplate. When aspirating from containers in certain sample processing step, one may desire to leave a defined residual volume in the containers—for example, to avoid disturbing or aspirating particles at the bottoms of the containers. Certain processing steps require consistent remaining volumes or undisturbed pellets at the bottoms of the containers. However, handheld pipette devices make this defined-level aspiration a manual, subjective process; and the process becomes particularly challenging when a multichannel pipette is used where the user has to keep the two terminal pipette tips aligned with the target wells simultaneously (the rest of the pipette tips are aligned correspondingly) as the tips are inserted into the containers, a process requiring steady and sustained control of the orientations and movements of the pipette and thus being attention-demanding. This is exacerbated in applications involving small fluid volume where there is more limited wiggle room allowed for the pipette tips. Additionally, variation in the inserting depth of a pipette tip is one of common factors for pipetting inaccuracy.

Fully-automated liquid handling robots, which can accomplish consistent defined-level aspiration, are commercially available, but they are expensive and require a different skill set for operation from the skills available to the typical laboratory operator. Consistent results for defined-level aspiration are difficult to achieve with the current manually operated single or multichannel pipettes.

U.S. Pat. No. 10,232,376 (issued on Mar. 19, 2019) describes an apparatus for limiting insertion of a pipette into a tube. While the concept of the device described, a spacer block for restricting the pipette travel beyond a predetermined limit, makes good sense, many difficulties would be encountered in actual use of the described device. First, the device has to be customized for almost every model of pipette to ensure the proper fit of the pipette heads with the holes on the top surface of the device. Second, the height of the spacer block, which correlates to the pipette tips insertion depth, cannot be adjusted once the device is made. In reality, a lab, or even a single user, may use a variety of pipettes, which may differ in size, manufacture, and model, in a variety of experimental procedures which may use a variety of pipette tip insertion depth; and also a pipette may be used with pipette tips of different length. All those may change frequently. This makes the device described in the patent less attractive or even impractical, except for an experiment with a fixed protocol and a fixed set of pipettes and pipette tips. Third, the device needs to be essentially disposable in the described ways of use. In one described way the device would be ejected along with the pipette tips for each pipette tip ejection by the ejection mechanism on the pipette, and in another described way the narrow holes on the top surface could be easily contaminated due to unintentional but difficult-to-avoid touching by the pipette tips when the tips are withdrawn out of the holes. The need for being disposable may make the device cost prohibitive. And fourth, the use of the device makes pipetting less efficient. Before mounting the pipette tips onto the multichannel pipette heads, the device has to be mounted either onto the pipette heads or over the sample tubes, which is an extra step one does not need to take in normal pipetting. Moreover, with the device mounted on the pipette heads, it is not straightforward to mount the pipette tips, because the device, a spacer block, may prevent the pipette heads travel close enough to the table surface to pick up the pipette tips, and thus another “spacer block” may be needed to raise the pipette tip rack.

### SUMMARY OF THE DISCLOSURE

The apparatus described in this disclosure aims for not only truly consistent results for defined-level aspiration in manual pipetting without the above limitations but also a less attention-demanding pipetting and more ergonomic process in general.

In an embodiment, an apparatus for limiting pipette travel with respect to a support surface, for placing sample containers is described. A stand controls the spatial positions relative to the support surface. A mechanism couples the pipette being used with the stand. The orientation and movement of the pipette is restricted to certain extent by the stand as predetermined.

### BRIEF DESCRIPTION OF THE DRAWINGS

For a better understanding, reference may be made to the accompanying drawings, in which:

FIG. 1 is a perspective view of one embodiment of the invention with linear slides.

FIG. 2 depicts a schematic side view of an embodiment example of coupling a multichannel pipette with the stand through snug-fitting.

FIG. 3 is a perspective schematic view of an embodiment example for coupling a multichannel pipette with the stand through magnetic force.

FIGS. 4A and 4B are partial perspective schematic views of an embodiment of the invention with a U-shaped upper arm in the stand and a horizontal bar on the pipette for restricting downward movement of the pipette.

FIG. 5 depicts schematically a side schematic view of an embodiment with a U-shaped upper arm with receptacles that accept the bar associated with a multichannel pipette.

FIG. 5A is a top partial view of a portion of FIG. 5.

A component or a feature that is common to more than one drawing is indicated with the same reference number in each of the drawings.

### DESCRIPTION OF THE EMBODIMENTS

This technology comprises, the following features, in any combination.

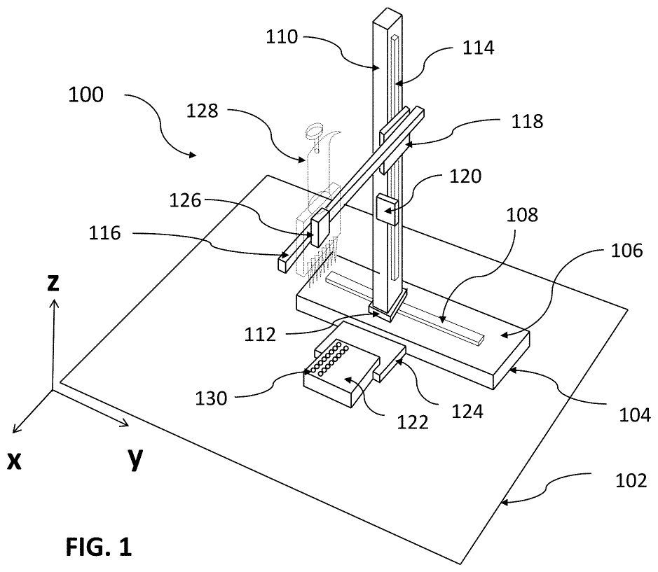

FIG. 1 depicts an apparatus 100 for limiting multi-channel pipette travel with respect to a support surface 102. The apparatus 100 may be made of or assembled from any desired material or mechanical components, and in any desired manner, such as 3D-printed (e.g., additively manufactured) from plastic, metal, or any other material, or machined from a block of any desired material. For example, the apparatus 100 could be assembled at least partially from aluminum strut profiles, available from Rexroth, A Bosch Company, Germany. For most use environments, the apparatus 100 will desirably be substantially rigid. In addition, it will often be desirable for the apparatus 100 to be able to be made while holding to fairly tight manufacturing tolerances, to resist deterioration arising from exposure to common laboratory chemicals/substances, and also to be capable of being sterilized.

The apparatus 100 includes bottom surface 104 on base frame 106, with which the apparatus stands on support surface 102. Optionally, the bottom surface 104 may be defined by the lowermost edges of 106, rather than being a separately provided “bottom surface” element. Also optionally, the bottom surface 104 may be contoured or otherwise configured to engage a feature of the support surface 102 as desired, such as to orient or position the apparatus 100 into a predetermined position with respect to the support surface 102.

The apparatus 100 also includes two linear slides. Linear slide rail 108 is mounted horizontally on base frame 106. Vertical pillar 110 is mounted on slide carriage 112 and is allowed to slide along slide rail 108 in horizontal direction (y direction). Linear slide rail 114 is mounted on vertical pillar 110. Horizontal bar 116 is mounted on slide carriage 118 and is allowed to slide along slide rail 114 in vertical direction (z direction). Vertical slide stop 120 is mounted on vertical pillar 110 for limiting the downward movement of slide carriage 118 or bar 116. In this configuration, the movement of arm 116 is allowed in the y and z directions within predetermined ranges but not in the x direction, and any rotations are limited. Microplate 122 is disposed on support surface 102 and is secured in position by plate holder 124 which is attached to base frame 104. After the pipette 128 is coupled with apparatus 100 through coupler 126, the movement of the pipette is restricted to the extent the linear slides allow, and the pipette tips are aligned with the target wells 130 of the microplate 122 (the row of tips and the row of target wells are parallel and any corresponding matching tip-well pair has essentially the same x direction coordinate shown in FIG. 1) and are prevented from traveling downward beyond the predetermined limit.

An example sequence for pipetting with the assistance of the apparatus may include, (a) raise the horizontal bar 116 somewhat, (b) attach the pipette to the horizontal bar 116, (c) move the pipette along with horizontal bar 116 until the pipette tips are directly over the target wells for aspiration, (d) lower the pipette along with the horizontal bars 116 until vertical stop 120 is met (the horizontal bar 116 is now at the predetermined height), (e) aspirate fluid from the wells, (f) raise the pipette along with bar 116 and, slide the bar 116 along with the pipette horizontally towards the target wells for dispensing (the target wells can be on the same microplate or on another microplate), and lower the pipette along with bar 116, and (g) dispense the fluid from the pipette tips. In regular pipetting with a multichannel pipette, a user has to monitor and control the movement of the two terminal pipette tips in x, y, and z directions simultaneously. With the assistance of the device depicted schematically in FIG. 1, a user only needs control a single pipette tip in two directions (y and z), and importantly, pipette tips are prevented from traveling down below the predetermined limit in z direction.

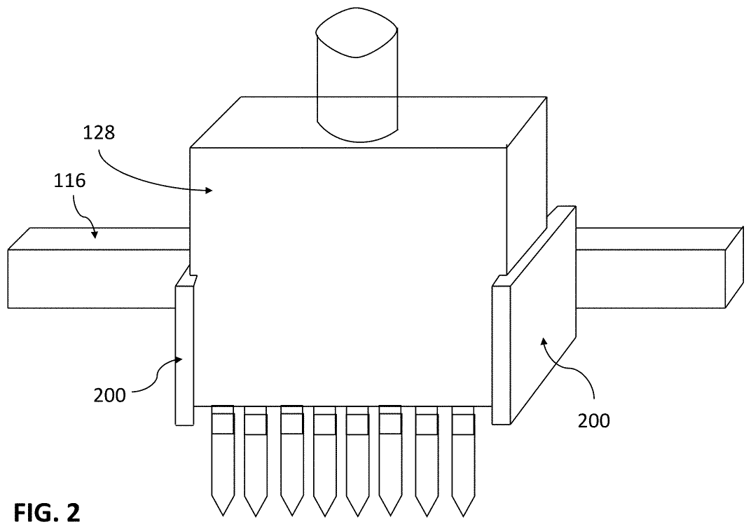

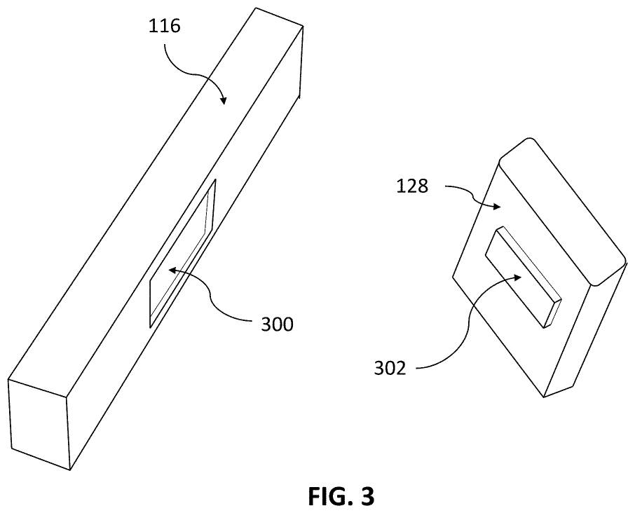

Examples of the mechanism for coupling the pipette with the stand are shown in FIG. 2 and FIG. 3. FIG. 2 depicts multichannel pipette 128 coupled with horizontal bar 116 through appropriate snug fitting. Coupler 200 mounted on horizontal bar 116 acts as a receptacle for the pipette body, allowing the pipette body to be inserted into the opening. The coupling is tight enough to lock the pipette into position and yet permits the pipette to be detached fairly easily. Suitable spring leaves can be used to achieve such appropriate tightness. FIG. 3 depicts pipette coupling aided by magnetic force. A thin piece of magnetic strip 300 is fixed, through means including gluing, onto the bottom of a recessed surface on horizontal bar 116, and the matching magnet strike plate 302 is fixed onto the side of pipette 128. When the pipette is brought close and the magnet strip 300 and matching strike plate 302 are roughly aligned, the matching strike plate is pulled towards and snug-fitted into the recessed area, resulting in the coupling of pipette 128 and bar 116 with appropriate tightness.

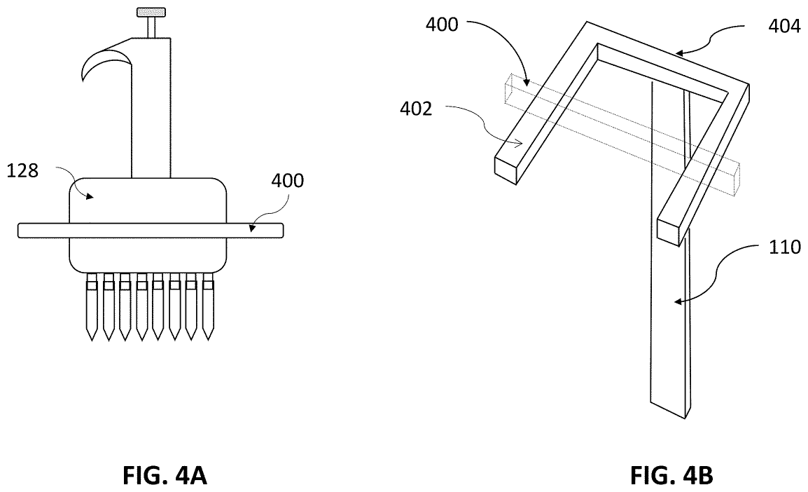

FIGS. 4A and 4B depict another embodiment for restricting the movement of the pipette through a stand and associating or coupling the pipette with the stand. Bar 400, perpendicular to the vertical axis of pipette 128, is attached to pipette 128. A U-shaped arm 402 is attached to vertical pillar 110 (FIG. 1) of the stand. The top surface 404 on upper arm 402 is in a substantially horizontal plane which is parallel to the support surface for placing the microplate or other sample rack. When the pipette is brought over arm 402 and lowered through the U-shaped opening towards the microplate, any further downward movement is limited once the two end parts of bar 400 contacts the top surface 404 of arm 402 (coupling of the pipette and the stand is achieved through this contacting), preventing the movement of the pipette transversely downward further than the predefined limit.

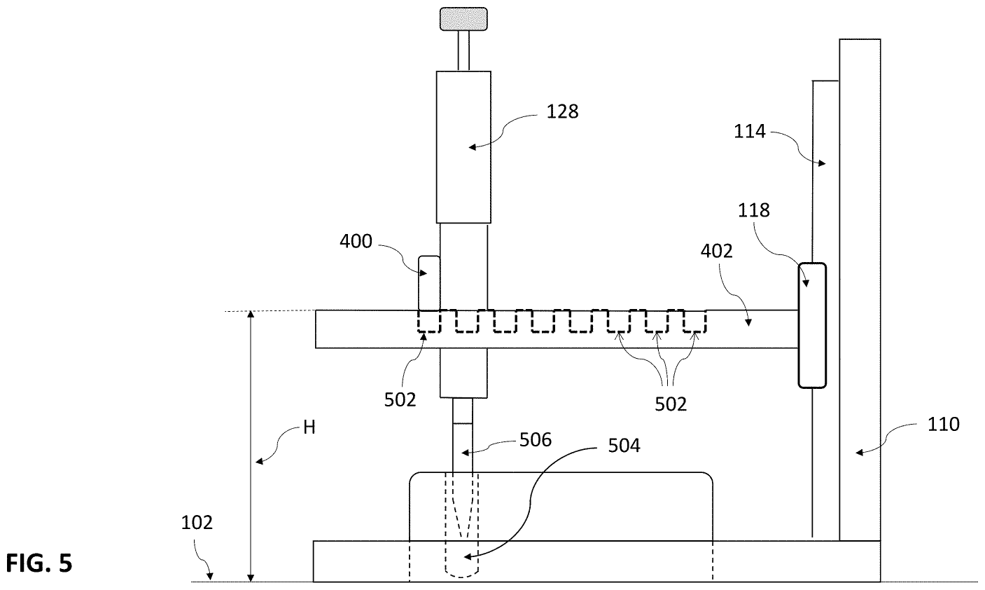

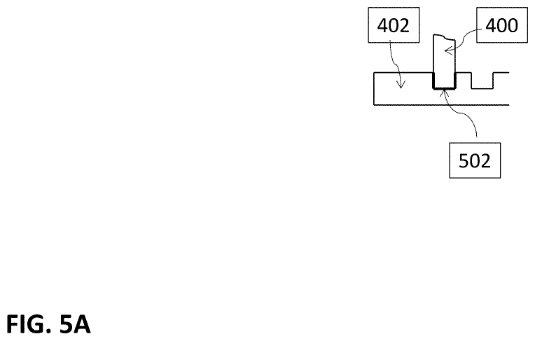

FIG. 5 depicts schematically a side view of a U-shaped upper arm 402 with receptacles 502 that accept the horizontal bar 400 that is associated with a multichannel pipette 128. The top partial view in FIG. 5A shows one end of bar 400 accepted by receptacle 502 on the upper arm 402. The relative positions of the receptacles and the wells below are so configured that when the bar 400 is accepted by the receptacles, the pipette tips are aligned with the target wells and not only further downward movement of the pipette is restricted, but also the motion of the pipette in the horizontal directions as well as the rotation along the pipette axis is restricted too; in other words, the pipette tip insertion depth is limited, and the unwanted motion and rotation are restricted. When fitting the ends of bar 400 into the receptacles 502 (coupling the pipette with the stand), the upper arm 402 can be lifted somewhat as an option for avoiding unintended touching with wells 504 by pipette tips 506, and subsequently the upper arm 402 is lowered together with the pipette and the pipette tips are inserted into the wells at the predetermined depth that is a function of the upper arm height setting H that is dependent on the vertical stop position.

The frame of the stand 100 is generally thin, rather than unnecessarily thick, to permit minimally obstructed view of the microplate wells and pipette tips during pipetting.

One of ordinary skill in the art could configure the sub-assembly for the adjustment of the position/height of vertical stop 120, e.g. using a screw jack operated either manually or electrically.

As is the case for a garage door, arm 116 can be spring-loaded so that it takes less force to lift arm 116 in the upward direction.

Plate holder 124 can be integrated into base frame 106, or a separate frame that can be attached to and detached from base frame 106 as needed. Plate holder 124 can be configured to hold one or more microplates in various orientation combinations.

In certain circumstances, one may desire to “semi-permanently” fix bar 400 or matching strike plate 302 onto the pipette, using means including a less “permanent” double-sided glue strip or more “permanent” epoxy glue.

From the above description and discussion, it should be clear that the apparatus disclosed in this application overcomes or address limitations of the device described in U.S. Pat. No. 10,232,376. The pipetting may be proceeded without extra step for mounting a device to the pipette heads or over the microplate wells before each aspiration; the apparatus 100 can be reused and has no tendency to cause contamination; the vertical stop height correlating to the pipette tip insertion depth is adjustable; and it is possible to mount a single bar to a wide variety of pipettes, for example, by using magnetic coupling of the bar to the pipette body. Hence, truly consistent results for defined-level aspiration in manual pipetting, without the many limitations of the prior art becomes achievable. Additionally, since the unwanted motion or rotation can be restricted, the pipetting process, with the assistance of the device, becomes less attention-demanding and more consistent. Once the pipette is coupled with the stand, the force needed to hold the pipette up at a given position is reduced and this may help avoid repetitive pipetting stress injuries.

Regardless of the exact nature of the relative configurations and locations of the pipette 128, microplate 122, and the mechanism to couple the pipette with the stand, it should be understood that the apparatus 100 can be used to limit an insertion depth of the pipette tips into the microplate well 130 by blocking downward travel of the multichannel pipette 128 beyond a predetermined distance with respect to support surface 102, in order to provide reproducible and consistent pipetting (e.g., aspiration) operations, such as in a laboratory bench environment. This property may be particularly desirable when the multichannel pipette 128 and associated parts of apparatus 100 are being operated manually by a user.

While aspects of this disclosure have been particularly shown and described with reference to the example embodiments above, it will be understood by those of ordinary skill in the art that various additional embodiments may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. Bar 400 can be an integrated part of pipette 128. Arm 402 may have marks to indicate the corresponding well location of the microplate, or grooves or channels on the top surface which acts as receptacles for guiding bar 400 into the proper location. These grooves or receptacles can be fixed at the predetermined location, or can be moved around as desired manually, staying “freely” or temporally and gently locked after each movement, or can be moved automatically by a motor or manually with a digital display such as with a caliper. Any of the described structures and components could be integrally formed as a single unitary or monolithic piece or made up of separate sub-components, with either of these formations involving any suitable stock or bespoke components and/or any suitable material or combinations of materials. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one embodiment or configuration could be provided, singly or in combination with other structures or features, to any other embodiment or configuration, as it would be impractical to describe each of the embodiments and configurations discussed herein as having all of the options discussed with respect to all of the other embodiments and configurations. One may also combine with other pipette accessories to further ease the burden and demand placed on the user, such as computer software or hardware guides that direct the user to particular well, rows of wells, or well groups, e.g., those discussed in U.S. Pat. No. 7,167,774. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof

What is claimed is:

1. An apparatus for controlling pipette motion, the apparatus comprising:
a) a stand for controlling spatial position relative to a support surface for placing sample containers, and
b) a mechanism for temporally coupling the pipette with the stand;
wherein at least one of motion, orientation of the pipette and unwanted motions or rotations of the pipette is limited by the stand for restricting insertion depth of the pipette tip or a plurality of pipette tips into a sample container or a plurality of sample containers, respectively.

2. The apparatus of claim 1, wherein the stand for controlling spatial position comprises at least one linear slide; in restricted spatial ranges, the pipette being coupled to the stand is allowed to be moved (a) freely or (b) in steps in horizontal direction corresponding to the column or row spacing of sample wells by a mechanical or electrical mechanism, but can move freely in vertical direction.

3. The apparatus of claim 2, wherein the mechanism for temporally coupling the pipette with the stand uses forces including friction force, tension force, spring force, and magnetic force; for coupling, in a snug-fitting fashion, and permits the stand to restrict at least one of motion and rotation of the pipette.

4. The apparatus of claim 2, wherein the stand comprises a vertical slide stop for restricting the vertical movement of the mechanism for coupling the pipette with the stand in a desired range.

5. The apparatus of claim 4, wherein the vertical slide stop position is set by one of an analogue and a digital caliper.

6. The apparatus of claim 2, wherein the stand has marks indicating the target sample rack row or column the pipette tips point to for a given configuration of the sample rack.

7. The apparatus of claim 2, wherein the stand allows the associated pipette access to a plurality of sample racks.

8. The apparatus of claim 7, wherein the sample racks are microplates.

9. The apparatus of claim 1, wherein the stand comprises an upper arm in rectangular or U shape, with an opening for pipette access; the arm being parallel to a support surface for placing sample racks or microplates; the pipette being prevented from traveling further down beyond a predetermined limit when certain positions of the pipette, or a component attached to the pipette, contact the top surface of the upper arm.

10. The apparatus of claim 9, wherein the opening of the top surface is narrower than the widest section of the pipette, and the pipette is prevented from traveling further down beyond a predetermined limit when the pipette body is blocked by the upper arm.

11. The apparatus of claim 9, wherein the opening of the top surface is narrower than a bottom surface near and above heads of the pipette, and the pipette is prevented from traveling further down beyond a predetermined limit when the bottom surface is blocked by the upper arm.

12. The apparatus of claim 9, wherein a relatively thin and narrow bar is combined with the pipette, oriented in a direction substantially perpendicular to a vertical axis of the pipette, spanning wider than the width of the opening on the upper arm and coming to a stop once contacting the upper arm by two ending parts of the bar in the process traveling down together with the pipette towards a sample rack or a microplate on the support surface.

13. The apparatus of claim 12, wherein the bar is combined with the pipette temporally through forces including friction force, tension force, spring force, and magnetic force, or permanently, or is simply built-in with the pipette.

14. The apparatus of claim 9, wherein the upper arm has a plurality of receptacles; the positions of the receptacles and the sample wells below are so configured that when a pipette feature is received by or fitted into the receptacles, the pipette tips are aligned with the target wells and the pipette is prevented from traveling downward further, rotating along the pipette axis, or moving in horizontal directions.

15. The apparatus of claim 14, wherein the receptacles are marked with corresponding target well row or column designations.

16. The apparatus of claim 1, wherein a hardware or software guide is added to direct users to the particular sample container, rows of sample containers or a group of sample containers.

17. The apparatus of claim 1, wherein sample containers are held at position by a holder.

18. The apparatus of claim 17, wherein the holder is an integral part of the stand.

19. The apparatus of claim 17, wherein the holder is coupled with the stand in one of a permanent or a detachable manner.

20. The apparatus of claim 17, wherein the holder accommodates a plurality of microplates in various orientation configurations.
